(19) United States
(12) Patent Application Publication
(10) Pub. No.: US 2020/0317160 A1
(43) Pub. Date: Oct. 8, 2020

(54) LIQUID DISTRIBUTION ASSEMBLY FOR A SENSOR CLEANING SYSTEM AND METHOD

(71) Applicant: DLHBOWLES, INC., Canton, OH (US)

(72) Inventors: Justin Albrecht, Canton, OH (US); Zachary Kline, Burtonsville, MD (US); Christopher Punzi, Columbia, MD (US); Alan Romack, Columbia, MD (US); Thao Nguyen, Silver Spring, MD (US); Perry Wadsworth, Canton, OH (US)

(21) Appl. No.: 16/839,817

(22) Filed: Apr. 3, 2020

Related U.S. Application Data
(60) Provisional application No. 62/828,665, filed on Apr. 3, 2019.

(51) Int. Cl. B60S 1/52; B08B 3/02; B08B 5/02; B60S 1/48

(52) U.S. Cl. CPC B60S 1/52; B60S 1/481; B08B 5/02; B08B 3/02

(57) ABSTRACT

A vehicle sensor cleaning system that includes one or more vehicle sensors and a cleaning device. The system may further include an area to accommodate expansion of fluids due to freezing, such as a spring-loaded expansion valve, a floating barb expansion valve, or a three-way valve to a standpipe. The system may include systems and methods to evacuate the manifold such as purging with compressed or ambient air, or a syringe or drain valve mechanism. The system may be heated by a heating device such as a PTC heater, a resistive wire, or a low current coil. The system may provide a track or line to recirculate the fluid. These systems and methods may be incorporated into any portion of the system and in any combination. The systems and methods may be actuated by a mechanical or electrical switch that turns on based on direct pressure as a result of expanding or freezing fluid, in response to input by a temperature, pressure, or other sensor, or in response to automated or user input. The manifold may also comprise various modules and connections to adapt the system to any vehicle as desired.

### CROSS REFERENCE TO RELATED APPLICATIONS

This applications claims the benefit of and priority to U.S. Provisional Application No. 62/828,665 entitled “LIQUID DISTRIBUTION ASSEMBLY FOR A SENSOR CLEANING SYSTEM AND METHOD” filed on Apr. 3, 2019, which is incorporated by reference in it entirety.

### FIELD OF INVENTION

The present teachings relate to vehicle sensor cleaning systems and methods, and more particularly, to vehicle sensor cleaning systems that prevent freezing of the fluid in the system or otherwise allow the fluid to freeze in a controlled manner, and that further enable customization and adaption of the system to any vehicle or sensor arrangement.

### BACKGROUND

Some vehicles include external sensors, including external view (e.g., front bumper, side-view, rear-view or back-up) cameras to enhance the driver's vision and to improve safety. For example, rearview or “back-up” camera systems are integrated into vehicles to minimize the likelihood of “backovers.” A backover is a specifically-defined type of accident, in which a non-occupant of a vehicle (i.e., a pedestrian or cyclist) is struck by a vehicle moving in reverse. Vehicles can include other cameras to see into any other blind spot around a vehicle's periphery (behind, to the side, in front, above). All of these cameras can include exterior lens surfaces which will eventually become soiled with environmental debris.

Vehicles can include other sensors such as infrared image sensors that are incorporated to provide additional information to the driver or for autonomous driving. These vehicles may utilize sensors for object detection, location tracking, and control algorithms. Such vehicles may have different levels or types of automation, such as driver assistance systems, electronic power assist steering, lane keeping assistance, adaptive cruise control, adaptive steering, blind spot detection, parking assistance, traction, and brake control. The various types of automation rely on sensor input for their control and functionality.

These external sensors are exposed to the external environment and are often soiled by environmental debris, including mud, salt spray, dirt, grime, dust, water, or other debris. Accumulating debris can distort an image, deteriorate accuracy, or may render sensor output unusable. It is therefore desirable to clean these sensing devices to reduce or eliminate the buildup of obstructive debris.

Additionally, traditional systems and methods of cleaning these sensors include the use of dry air or machined stainless steel lines. Systems that use fluid to clean a vehicle's sensors may be susceptible to damage resulting from freezing and/or thawing of the fluid in the lines. The use of machined stainless steel lines may be generally unable to handle high stress.

With an increasing number of sensors on vehicles that require cleaning in order to maintain proper functionality, it is desirable to efficiently clean external sensing devices by cleaning only those sensors that need to be cleaned at that time. It is also desirable to provide a system and method of cleaning sensors with a fluid that reduces or prevents damage to the system and the lines as a result of extreme temperatures or due to freezing and/or thawing. It is further desirable to provide a system and method of cleaning sensors that is customizable and adaptable to the system of any vehicle or sensor arrangement.

### SUMMARY

Disclosed is a modular liquid distribution manifold assembly. The modular liquid distribution manifold assembly may be used in a sensor cleaning system configured to clean at least one sensor mounted to a vehicle. In an embodiment, the modular liquid distribution manifold assembly may comprise: a first fluid gallery or housing including a main fluid line, at least one branch valve, an inlet, and an outlet member. The main fluid line may attach to and be in fluid communication with the inlet, the branch valve, and the outlet member. The inlet may be configured to be placed in fluid communication with a fluid reservoir. The branch valve may be configured to be attached to a fluid line. The outlet member may be positioned along an exterior portion of said fluid gallery and may be configured to be attached to a second fluid gallery. In an embodiment, the outlet member may be placed in a normally closed position.

The modular liquid distribution manifold assembly may further comprise at least one expansion control device positioned in communication with at least one of the inlet, the main fluid line, the branch valve, or the outlet member. The expansion valve may be configured to reduce fluid pressure within the liquid distribution manifold due to freezing and thawing of the fluid.

In an embodiment, the fluid gallery may include a plurality of branch valves wherein each of said branch valves may be configured to be placed in an open and closed position to distribute fluid to fluid lines and nozzles attached thereto to spray fluid therefrom to clean a sensor positioned along an exterior of a vehicle.

In an embodiment, the expansion control device may be a spring-loaded expansion valve that includes an expansion pocket. In an embodiment, the expansion pocket may be spring-loaded and biased to a closed position. In an embodiment, the expansion control device may be a three way spring-loaded valve wherein an inlet of the expansion control device may also serve as an outlet. The expansion pocket may be configured to receive overflow fluid when the fluid drops below a freezing temperature. The expansion pocket may be in a closed position when the fluid is above a freezing temperature and may operatively open into an open position when the fluid is below the freezing temperature.

In an embodiment, the expansion control device may include a release valve. The release valve may be spring-loaded and biased to a closed position. In an embodiment, an outlet of the release valve may be open to ambient air. The expansion control device may be configured to receive ambient or compressed air to purge fluid from the liquid distribution manifold.

In an embodiment, the expansion control device includes a heating mechanism. In an embodiment, the expansion control device may include a recirculation system. In an embodiment, the expansion control device may be positioned at an end of the first fluid gallery.

In an embodiment, the outlet member may be placed in an open condition and may be attached to a second fluid gallery. The second fluid gallery may have a main fluid line, at least one branch valve, an inlet, and an outlet member, where the main fluid line may be attached to and in fluid communication with the inlet, the at least one branch valve, and the outlet member, where the inlet may be placed in fluid communication with the first gallery and where the branch valve may be configured to be attached to a fluid line.

In an embodiment, the first fluid gallery and the second fluid gallery may be connected by male and female mating portions. The first fluid gallery may include an elongated protrusion and the second gallery may include a receiving portion wherein the receiving portion may be configured to receive the elongated protrusion such that the elongated protrusion and the receiving portion may be spaced from the outlet member and the inlet of the second fluid gallery.

Disclosed is a method of cleaning a plurality of sensors mounted to an exterior of a vehicle. In an embodiment, the method may comprise: providing a modular liquid distribution manifold that may include a first fluid gallery having a main fluid line, a plurality of branch valves, an inlet, and an outlet member, where the main fluid line may be attached to and in fluid communication with the inlet, the plurality of branch valves, and the outlet member, where the inlet may be in fluid communication with a fluid reservoir and a pump, where the plurality of branch valves may be attached to a plurality of fluid lines having a plurality of nozzles such that said nozzles may be placed along an exterior of a vehicle and each of the plurality of nozzles may be placed adjacent to a sensor. The method may further comprise: sensing, with at least one sensor, the presence of debris; controlling, with the processor, at least one of the plurality of branch valves to place said branch valve in an open position; controlling, with the processor, the pump to cause fluid flow through the liquid distribution manifold; and spraying fluid from at least one of said plurality of nozzles to clean debris from the at least one sensor.

In an embodiment, the method may further comprise providing at least one expansion control device that may be positioned in communication with at least one of the inlet, the plurality of branch ports, and the outlet, where the expansion valve may be configured to reduce fluid pressure within the liquid distribution manifold due to freezing and thawing of the fluid. In an embodiment, the method may further comprise providing a second fluid gallery and attaching said second fluid gallery to the first fluid gallery. The second fluid gallery may have a main fluid line, at least one branch valve, an inlet, and an outlet member, where the main fluid line may be attached to and in fluid communication with the inlet, the branch valve, and the outlet member, where the inlet may be in fluid communication with the first fluid gallery to increase the number of nozzles controlled by the liquid distribution manifold.

### DESCRIPTION OF THE DRAWINGS

The present teachings may be better understood by reference to the following detailed description taken in connection with the following illustrations, wherein:

FIG. 1 is an schematic top view of vehicle sensor cleaning system and vehicle in accordance with various disclosed aspects;

FIG. 2A shows an exemplary fluid distribution manifold of a vehicle sensor cleaning system in accordance with various disclosed aspects;

FIG. 2B shows an exemplary fluid distribution manifold of a vehicle sensor cleaning system in accordance with various disclosed aspects;

FIG. 3A illustrates an embodiment of a vehicle sensor cleaning system including a spring-loaded expansion valve in accordance with various disclosed aspects;

FIG. 3B illustrates an magnified view of the vehicle sensor cleaning system in FIG. 3A including a spring-loaded expansion valve in accordance with various disclosed aspects;

FIG. 4 illustrates an embodiment of a vehicle sensor cleaning system including a floating barb expansion valve in accordance with various disclosed aspects;

FIG. 5A illustrates an embodiment of a vehicle sensor cleaning system including a three-way valve in an open position in accordance with various disclosed aspects;

FIG. 5B illustrates an embodiment of a vehicle sensor cleaning system including a three-way valve in a closed position accordance with various disclosed aspects;

FIG. 6 illustrates an embodiment of a vehicle sensor cleaning system including a compressed air manifold in accordance with various disclosed aspects;

FIG. 7 illustrates an embodiment of a vehicle sensor cleaning system including an ambient air valve in accordance with various disclosed aspects;

FIG. 8 illustrates an embodiment of a vehicle sensor cleaning system including a heating portion in accordance with various disclosed aspects;

FIG. 9 illustrates an embodiment of a vehicle sensor cleaning system including a retrack gallery and impeller in accordance with various disclosed aspects;

FIG. 10A illustrates a side view of embodiment of a vehicle sensor cleaning system including possible positioning of expansion valves or sensors in accordance with various disclosed aspects;

FIG. 10B illustrates a front view of an embodiment of a vehicle sensor cleaning system including possible positioning of expansion valves or sensors in accordance with various disclosed aspects;

FIG. 11A illustrates a system used for obtaining the experimental results shown in Table 1 in accordance with various disclosed aspects;

FIG. 11B illustrates a system used for obtaining the experimental results shown in Table 1 in accordance with various disclosed aspects;

FIG. 12A illustrates an embodiment of modular components of a vehicle sensor cleaning system and connectivity thereof in accordance with various disclosed aspects;

FIG. 12B illustrates an embodiment of modular components of a vehicle sensor cleaning system and connectivity thereof in accordance with various disclosed aspects;

FIG. 12C illustrates an embodiment of modular components and mating portions of a vehicle sensor cleaning system and connectivity thereof in accordance with various disclosed aspects;

FIG. 12D illustrates a cross-sectional view of an embodiment of modular components and mating portions of a vehicle sensor cleaning system and connectivity thereof in accordance with various disclosed aspects;

FIG. 13A illustrates an embodiment of modular components of a vehicle sensor cleaning system and connectivity thereof in accordance with various disclosed aspects;

FIG. 13B illustrates an embodiment of modular components of a vehicle sensor cleaning system and connectivity thereof in accordance with various disclosed aspects;

FIG. 14A illustrates an embodiment of modular components of a vehicle sensor cleaning system and connectivity thereof in accordance with various disclosed aspects;

FIG. 14B illustrates an embodiment of modular components of a vehicle sensor cleaning system and connectivity thereof in accordance with various disclosed aspects;

FIG. 14C illustrates an embodiment of modular components of a vehicle sensor cleaning system and connectivity thereof in accordance with various disclosed aspects;

FIG. 15A illustrates an embodiment of modular components of a vehicle sensor cleaning system and connectivity thereof in accordance with various disclosed aspects;

FIG. 15B illustrates an embodiment of modular components of a vehicle sensor cleaning system and connectivity thereof in accordance with various disclosed aspects;

FIG. 16A illustrates an embodiment of modular components of a vehicle sensor cleaning system and connectivity thereof in accordance with various disclosed aspects; and

FIG. 16B illustrates an embodiment of modular components of a vehicle sensor cleaning system and connectivity thereof in accordance with various disclosed aspects.

### DETAILED DESCRIPTION

Reference will now be made in detail to embodiments of the present teachings, examples of which are illustrated in the accompanying drawings. It is to be understood that other embodiments may be utilized and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

As used herein, an external sensor generally refers to a device exposed to an external environment of a vehicle to sense driving conditions, environmental conditions, or the general surroundings of the vehicle. Such external sensors may include visual light sensors or cameras (e.g., charge-coupled device, complementary metal-oxide semiconductor devices, etc.), radio detection and ranging (radar) sensors, light direction and ranging (LiDAR) sensors, and other types of sensors. Such sensors may be utilized to assist users in operation of a vehicle (e.g., blind spot monitoring, backup cameras, etc.). In another aspect, external sensors may be utilized for driverless or autonomous vehicles. Moreover, embodiments may refer to external sensors as exposed to an external environment where the external sensor may be disposed in a housing with a lens or other shielding device separating the external sensor from direct contact with the environment. As such, the lens may be considered a portion of the external sensor that is exposed to the external environment.

Described embodiments generally refer to a vehicle sensor cleaning system. A vehicle sensor cleaning system may automatically or autonomously (e.g., without user actuation) clean one or more external sensors based on an algorithm. The algorithm may determine cleaning parameters based on operating parameters associated with operation of the vehicle, an external environment, or stored preferences. For instance, the vehicle sensor cleaning system may utilize available data from the vehicle and other sources to clean sensors at operative times in an appropriate way. Some embodiments may prioritize which sensors are cleaned under which circumstances. Moreover, described vehicle sensor cleaning systems may control cleaning processes to conserve cleaning fluid or power. As such, aspects disclosed herein may improve safety, accuracy of sensors, and environmental impacts associated with reduced use of cleaning solutions.

Both fully Autonomous Vehicles (Level 4 & 5) and vehicles that have driver assistance systems (ADAS—Level 1-3) that utilize sensors which may be cleaned by described embodiments for improved safety, reliability and function. As vehicles are exposed to debris and other environmental factors (e.g., temperature, etc.), the differing environmental conditions, vehicular situations, vehicle hardware and debris types are a few examples of real world variables or operating parameters that may be utilized by disclosed embodiments to determine an effective time to clean, method of cleaning, cleaning duration, type of fluid (types of liquid or air) or other parameters of a cleaning event. The described vehicle sensor cleaning systems may remove chances for human error and may result in more efficient cleaning.

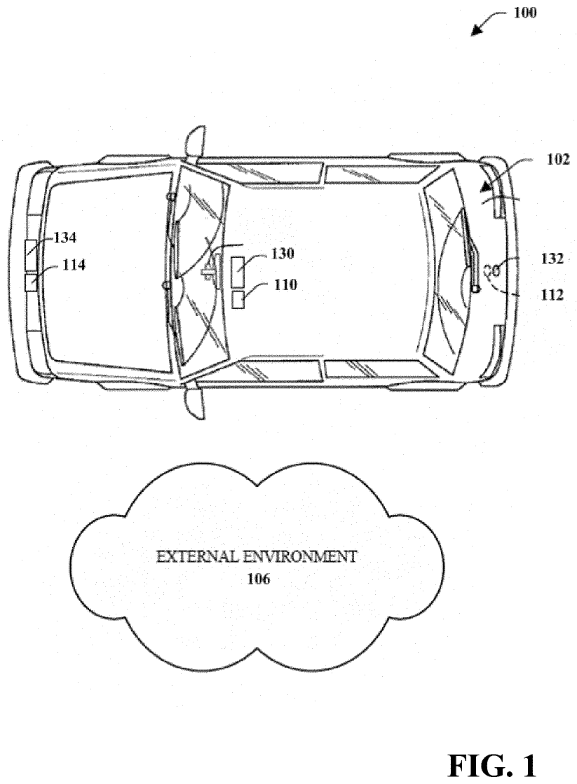

Turning to FIG. 1, there is an exemplary environmental view of a vehicle sensor cleaning system 100 for a vehicle 102. The vehicle sensor cleaning system 100 may include a processor, a memory, cleaning system sensors, cleaning devices, and user interface(s). It is noted that memory may store computer executable instructions or logic which may be executed by processor. In an aspect, executed instructions may control or instruct the various components described herein. It is noted that the vehicle sensor cleaning system 100 may include similar aspects as described with reference to the other figures and the various disclosed embodiments.

The vehicle sensor cleaning system 100 may include external sensors 130, 132, 134 and associated cleaning devices 110, 112, and 114, respectively. A processor may be disposed in the vehicle 102, such as in a dashboard or control panel of the vehicle 102. The various external sensors 130, 132, 134 and cleaning devices 110, 112, and 114 may be located at different positions (e.g., front, back, top, side, etc.) on or within the vehicle 102 and may comprise different orientations (e.g., rear facing, front facing, side facing etc.). Moreover, the various external sensors 130, 132, 134 and cleaning devices 110, 112, and 114 may comprise different attributes, such as types of sensors, types of cleaning devices, makes or models of sensors or cleaning devices, or the like. The processor may utilize the attributes to determine parameters for a cleaning event in conjunction with information about an external environment 106. For instance, different cleaning devices 110, 112, and 114 may comprise different capabilities or may be connected to different types of cleaning solutions, fluids, or gases (such as pressurized air). Moreover, different external sensors 130, 132, 134 may require different cleaning solutions, spray patterns, times of spray, pressure, or other parameter. The processor may utilize such information to determine intelligent parameters for a cleaning event.

The processor may receive input from cleaning system sensors, external sensors, or input from other sources, such as a smartphone or GPS unit, a vehicle, or other sources. The processor may utilize the input to determine when to execute and execute a cleaning process. The processor may receive information regarding ambient temperature (external to the vehicle), weather conditions (e.g. rain, clear, snow, etc.), location (e.g., based on GPS, Wi-Fi networks, triangulation, etc.), road conditions or expected road conditions, sensor types, sensor lens sizes and coating, vehicle speed, type of debris on sensor lens (e.g. mud, road spray, bugs, etc.), current outputs or items detected by cleaning system sensors or external sensors (signal strength or object classification), or other types of information. The processor may utilize some or all of this information to determine parameters for a cleaning process, such as cleaning fluid temperature, cleaning type and solution, cleaning duration, cleaning flow rates, cleaning pressures, any delayed cleaning, or other parameters.

The cleaning system sensors may include temperature sensors, pressure sensors, wind speed sensors, tire speed sensors, light sensors, accelerometers, gyroscopes, or other devices. For example, an accelerometer may be utilized to determine road conditions (e.g., bumpy, smooth, uphill, downhill, etc.), a vehicle direction of travel (e.g., forward, reverse, etc.), vehicle speed, or other parameter. In other examples, the cleaning system sensors may determine operating conditions such as vehicle speed, vehicle weight, brake conditions, or road conditions.

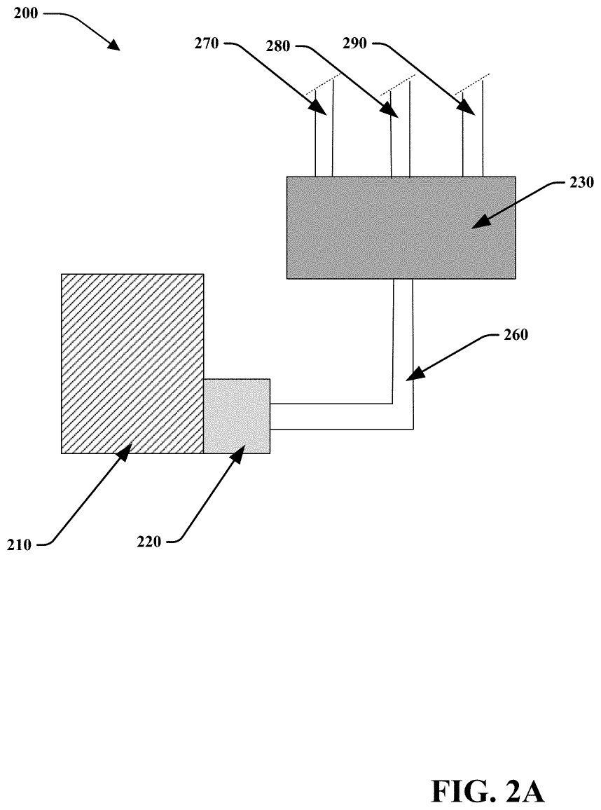

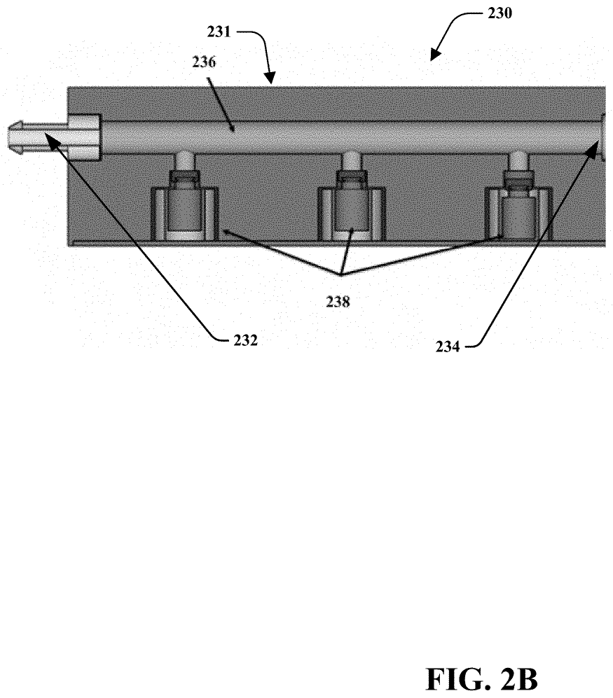

Turning to FIG. 2A, a partial exemplary fluid distribution manifold 200 of a vehicle sensor cleaning system 100 is shown. The distribution manifold 200 may comprise a reservoir 210, a pump 220, at least one fluid gallery 230, and a plurality of fluid lines 260, 270, 280, 290, etc. The reservoir 210 may include at least one fluid. In an embodiment, the fluid may include cleaning solutions, water, air, a combination thereof, or any appropriate fluid for cleaning a sensor. The fluid lines 260, 270, 280, 290 may be plastic, rubber, metal, or any polymer or molded material configured to communicate fluid therein. In an embodiment, the components of the distribution manifold may be 3D printed utilizing additive manufacturing technics or may be molded, stamped, extruded or manufactured in any known method. The pump 220 may be in fluid communication with fluid line 260 to allow fluid to flow from the reservoir 210 and control fluid flow from the reservoir 210 to the remaining components of the fluid distribution manifold 200. In an example, the pump 220 may enable fluid flow from the reservoir 210 to the fluid gallery 230 by a first fluid line 260. The fluid gallery 230 may then distribute the fluid to another fluid gallery or to other fluid lines 270, 280, 290. The other fluid lines 270, 280, 290 may be in fluid communication to another fluid gallery or with a nozzle that distributes the fluid to a sensor, such as those illustrated in FIG. 1. It is noted that the system may include any number of reservoirs, pumps, fluid lines, and fluid galleries as may be desired, and that any series of connections may be encompassed in this disclosure.

As shown in FIG. 2B, the fluid gallery 230 may include a housing 231 that includes an inlet 232, an end or output 234, a main fluid line 236, and a plurality of branched valves 238 and fluid lines that may be in fluid communication with a plurality of nozzles or another fluid gallery 230. In an example, the inlet 232 and main fluid line 236 may be in fluid communication with the reservoir 210 and pump 220, and the main fluid line 236 may further distribute the fluid to valves and nozzles. In an embodiment, the nozzles may transition between an open and closed state to allow fluid to a specific sensor. Moreover, in embodiments with multiple fluid galleries, the inlets or outlets of each fluid gallery may similarly open and close to direct fluid to a certain sensor or sensors. As disclosed herein, multiple fluid galleries may be connected in series by creating a fluid communication between the respective inlets and outlets. In an embodiment, the valves 238 may transition between an open and a closed state, based on communications from a processor, for example, to allow fluid to a specific sensor.

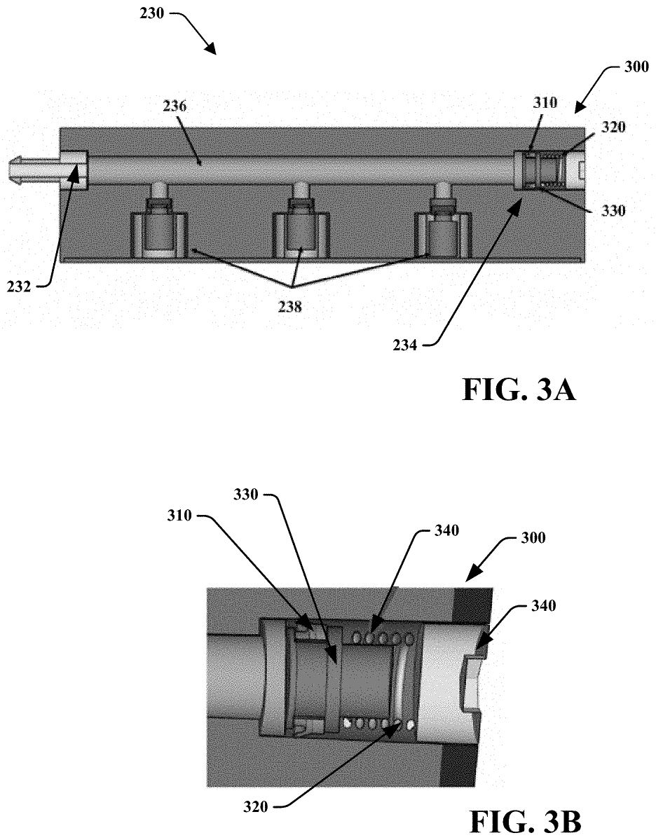

Turning to FIGS. 3A and 3B, a spring-loaded expansion valve 300 is shown. The spring-loaded expansion valve 300 may be located anywhere in the fluid distribution manifold 200, such as the inlet 232, outlet or end 234, or valves 238 of the fluid gallery 230, in the fluid lines 260, 270, 280, 290, in the reservoir 210, in the pump 220, in the housing 231 or even in the nozzles, etc. In an embodiment, the spring-loaded expansion valve 300 may be located at the end 234 of the fluid gallery 230. The spring-loaded expansion valve 300 may comprise a shaft seal 310, a spring 320, a seal carrier 330, and an expansion pocket 340. In an embodiment, the expansion pocket 340 may generally be filled with air. The spring 320 may be located in the expansion pocket 340 and bias the shaft seal 310 and seal carrier 330. Under normal fluid pressures, e.g. general operation of the vehicle sensor cleaning system, the spring may bias the shaft seal 310 and seal carrier 330 against the main fluid line 236 in a closed position. In an embodiment, the closed position would generally keep fluid within the main fluid line 236 or fluid distribution manifold 200. In this embodiment, minimizing the movement of the spring 320 in the spring-loaded expansion valve 300 during normal fluid pressures may ensure consistent system response time. On the other hand, if the shaft seal 310, seal carrier 330, and spring 320 were to move under normal operating pressures and allow fluid to enter the spring-loaded expansion valve 300, response time might be increased.

The spring-loaded expansion valve 300 may transition from a closed to an open position upon freezing pressures wherein the fluid freezes and begins pressing against the valve 300. In an embodiment, the freezing pressure of the fluid is greater than normal operating pressures of the fluid. Under freezing pressures, the spring 320 may be compressed and the shaft seal 310 and seal carrier 330 may move into the expansion pocket 340 or air gap. The expansion of the freezing fluid would be able to operatively enter the expansion valve 300 and prevent damage to the fluid lines or cleaning system that may otherwise occur due to the uncontrolled expansion of the fluid in freezing temperatures. The shaft seal 310 and seal carrier 320 may prevent fluid from entering the expansion pocket 340. In an embodiment, the expansion valve is able to be expanded to accommodate about 10% expansion of freezing fluid. In other embodiments, the allotted expansion may be about 20%, 30%, or 40% freezing fluid. As the fluid unfreezes, the pressures may return to normal operating pressures and the spring 320 may expand to position the expansion valve 300 back in a closed position where the shaft seal 310 and seal carrier 330 is biased against the main fluid line 236 and the fluid is retained in the main fluid line 236. The transition between open and closed positions may occur as many times as needed to accommodate freezing fluids. A plug 342 may be provided to allow access to within the expansion pocket 340 and may be operatively removed to allow fluid to be drained therefrom.

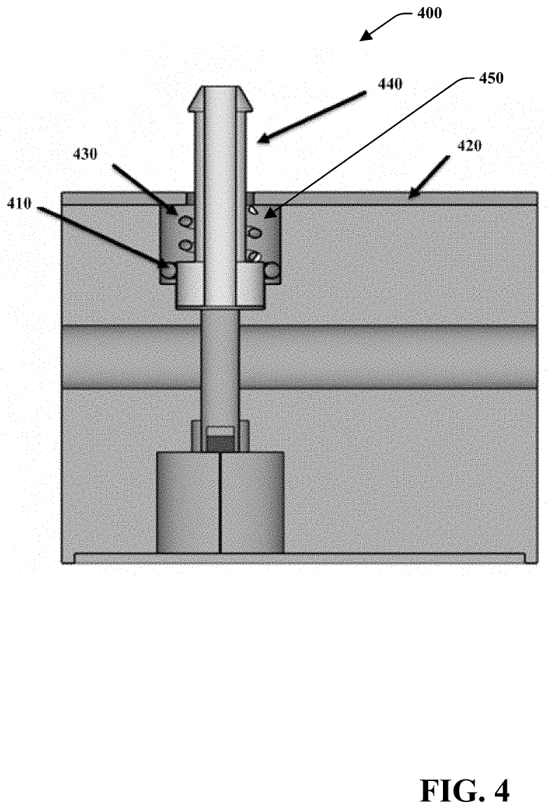

Turning to FIG. 4, a floating barb expansion valve 400 is shown. The floating barb expansion valve 400 may be located anywhere in the fluid distribution manifold 200, such as the inlet 232, outlet or end 234, or valves 238 of the fluid gallery 230, the housing 231, in the fluid lines 260, 270, 280, 290, in the reservoir 210, in the pump 220, in the nozzles, etc. In an embodiment, the floating barb expansion valve 400 may be located at each of the valve outlets 238 of the fluid gallery 230. In an embodiment, the expansion volume may be proportional to the number of valve outlets 238 of the fluid gallery 230. The floating barb expansion valve 400 may comprise a sealing ring 410, a spring compression plate 420, a spring 430, and an outlet barb 440. In an embodiment, the sealing ring 410 may be an O-ring. Similar to the spring-loaded expansion valve 300, each of the barbs may have room to move in an expansion pocket 450. When freezing pressures occur, the floating barb expansion valve 400 may move and accommodate the freezing fluid. The outlet barb 440 may be configured to fluid connection with the fluid lines.

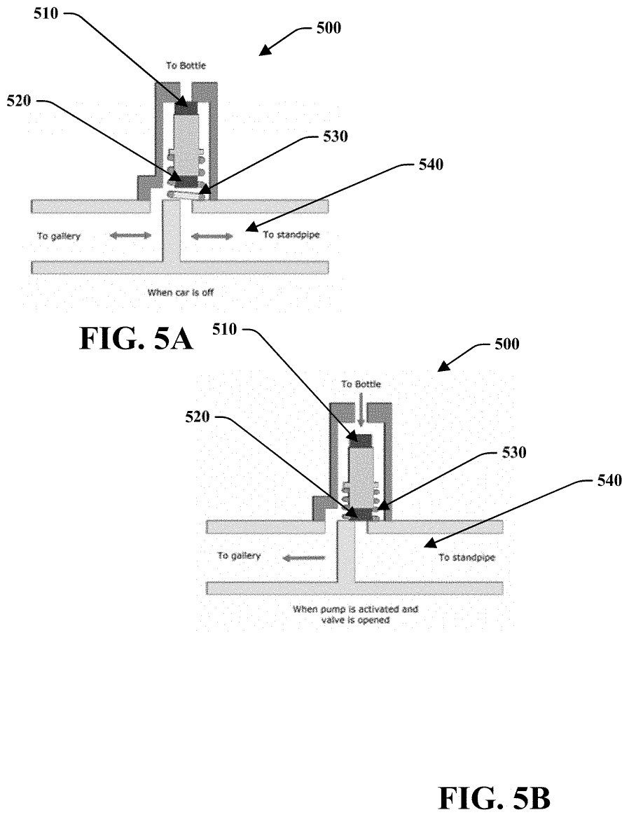

Turning to FIGS. 5A and 5B, a three-way valve 500 is shown. The three-way valve 500 may be located anywhere in the fluid distribution manifold 200, such as the inlet 232, outlet or end 234, or valves 238 of the fluid gallery 230, the housing 231, in the fluid lines 260, 270, 280, 290, in the reservoir 210, in the pump 220, in the nozzles, etc. In an embodiment, the three-way valve 500 may be located at inlet 232 of the fluid gallery 230, for example, connecting the reservoir 210 to the fluid gallery 230. The three-way valve 500 may include a pressure plate 510, a sealing cap 520, and a spring 530. In an embodiment the three-way valve may further include a standpipe 540. In an embodiment, the standpipe may be open to ambient air. The three-way valve 500 may selectively direct fluid flow from the reservoir 210 to the gallery 230. In an embodiment, the three-way valve 500 may connect the reservoir 210 to the fluid gallery 230 when the vehicle is on. The three-way valve 500 may selectively allow for any expansion or overflow of fluid from the fluid gallery 230 into the standpipe 540. In an embodiment the three-way valve 500 may connect the fluid gallery 230 to the standpipe 530 when the vehicle is off.

For example, the spring 530 may bias the pressure plate 510 against the fluid line connecting to the reservoir 210. Upon normal operating pressure, the fluid may press against the pressure plate 510, move the pressure plate 510 from a closed position to an open position, and compress the spring 530 so as to allow fluid communication between the reservoir 210 and the fluid gallery 230. In an embodiment, when the spring 530 is compressed, the sealing cap 520 of the three-way expansion valve 500 may press against an entrance to the standpipe 540, thereby preventing flow of fluid into the standpipe 540 in an open position. When fluid is not actively flowing through the vehicle sensor cleaning system, the spring 530 may expand and force the pressure plate 510 back against the fluid line connecting to the reservoir 210. In this closed position, when the spring 530 is expanded, sealing cap 520 may move away from the entrance to the standpipe 540 and the entrance to the standpipe 540 may be accessed from the fluid gallery 230 such that any freezing and expanding fluid may overflow from the fluid gallery 230 into the standpipe 540.

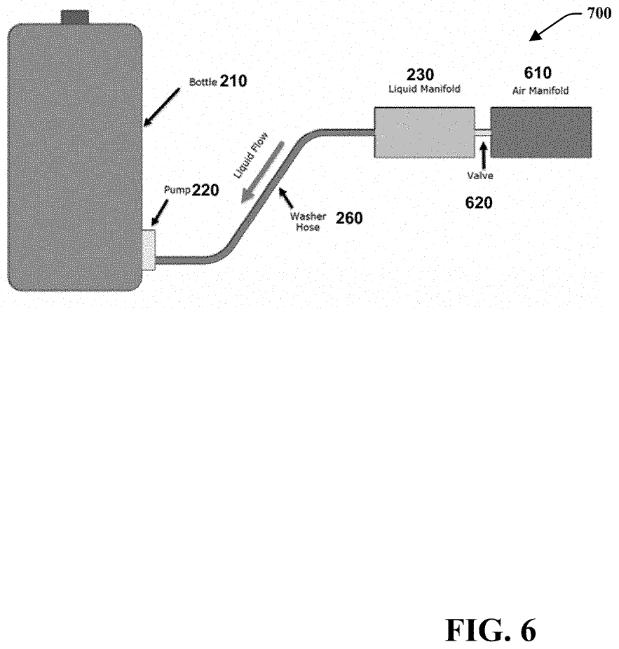

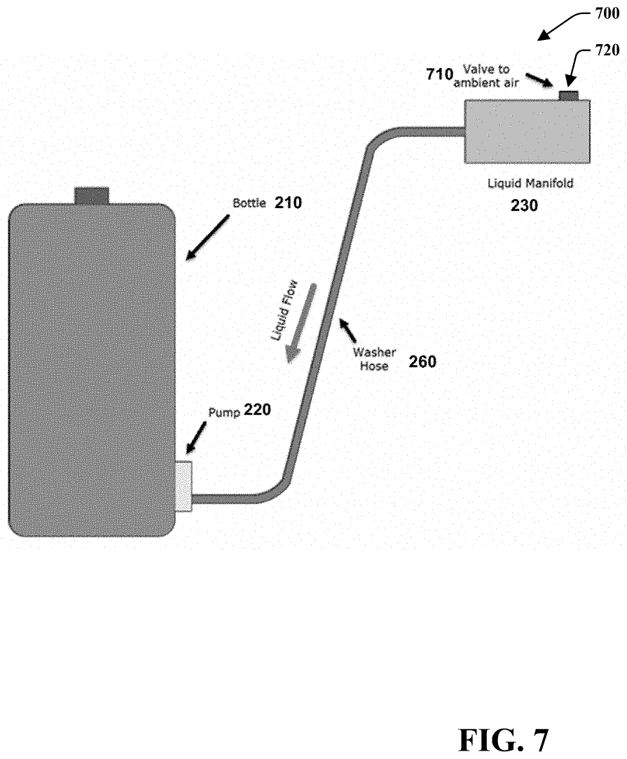

Turning to FIGS. 6-7, illustrated are embodiments of a controlled expansion area that may accommodate the increased volume of a freezing fluid. Here, freezing and expansion of the fluid may be controlled by evacuating fluid from all or a portion of the fluid distribution manifold 200. In an embodiment, as shown in FIG. 6, the fluid distribution manifold 200 may be purged with compressed air. For example, the fluid distribution manifold 200 may further include an air manifold 610 and a valve 620. In an embodiment, the air manifold 610 may include compressed air. The valve or port 620 may be positioned between the air manifold 610 and liquid distribution manifold 200, wherein the valve 620 may selectively transition between an open and a closed position to control the flow of air into the fluid distribution manifold 200. In an open position, the introduction of air may cause the fluid in the manifold 200 to regress back through the system and eventually back into the reservoir 210. The additional space in the manifold 200 now filled with air instead of fluid may accommodate any expanding or freezing fluid and the increased volume thereof.

In an embodiment, as shown in FIG. 7, the fluid distribution manifold 200 may be purged with ambient air. For example, a nozzle 710 may be provided at a position that is vertically higher than the fluid distribution manifold 200, including the main fluid gallery 230 and reservoir 210. In this embodiment, the valve 720 leading to the nozzle 710 may be opened and allow ambient air to enter the nozzle 710 and cause the fluid to revert back through the fluid distribution manifold 200, purging the main fluid gallery 230, and eventually back into the reservoir 210. The length of time the valve 720 is opened may be manipulated to control the volume of fluid purged in the system. For example, the longer length of time the valve 720 is open, the more fluid that will be purged back through the system into the reservoir 210. On the other hand, if the valve 720 is open for a discrete period of time, the volume of fluid purged may be less. It is noted that the volume of fluid purged is proportional to the expansion area available to accommodate freezing fluids. In another embodiment, if no nozzles 710 are higher than the liquid distribution manifold 200, an additional port 730 may be provided on the manifold 200 to allow ambient air to enter the gallery 230 when open, displacing fluid back to the reservoir 210. In this embodiment, lines between the other valve and nozzles would remain primed.

In another embodiment, the fluid distribution manifold 200 may be purged by a cylinder. In an embodiment, the cylinder is a syringe. The cylinder may be pneumatically or electrically activated, or may be activated by any other method. Once activated, the cylinder may displace part of the fluid from the fluid distribution manifold 200, such as the main fluid gallery 230 or block, by inserting air into the fluid distribution manifold 200. The displaced fluid and portion of the fluid distribution manifold 200 now filled with air may allow for expansion of any freezing fluid. In an embodiment, the cylinder or syringe may inject a fixed volume of air into the fluid distribution manifold 200. In an embodiment, the process may be reversed and the inserted air may be withdrawn from the fluid distribution manifold 200, allowing the fluid to return to the system. The inserted air may be withdrawn back into the cylinder or released into the environment, for example, by a standpipe. In an embodiment, the cylinder may include a one way valve so that fluid cannot flow from the fluid distribution manifold 200 into the cylinder and after injection, and the cylinder may be refilled by ambient air, for example, when it retracts.

In another embodiment, the fluid distribution manifold 200 may be purged by a drain valve. In an embodiment, the fluid from the fluid distribution manifold 200, such as the main fluid gallery 230 or block, may be purged into the exterior under certain conditions, such as freezing conditions. In an embodiment, the drain valve may comprise additional valves, such as 2-3 more valves. In an embodiment, one of the additional valves may be a three way solenoid valve. It is noted that any number of valves may be utilized. In an embodiment, the main fluid gallery 230 or block may be closed off by a valve. For example, a valve may selectively control the fluid flow from the reservoir 210 to the input 232 of the main fluid gallery 230. In an embodiment, once the valve stops the fluid flow between the reservoir 210 and the main fluid gallery 230, the fluid remaining in the fluid distribution manifold 200 downstream from the valve may be purged and any additional fluid flow from the reservoir 210 or upstream of the valve would be prevented. The fluid may be purged by any method, such as by opening a nozzle, directing the flow of the purged fluid to a standpipe, etc. The drain valve may further include a port that is opened to the atmosphere to allow the purged fluid to be replaced with ambient or compressed air. The port may be positioned anywhere in the vehicle sensor cleaning system. In an embodiment, this valve may be used if the main fluid gallery 230 is below the washer bottle or reservoir 210. In an embodiment where the main fluid gallery 230 is higher than the washer bottle or reservoir, the fluid in the system may be purged without a valve. In an embodiment, the three way valve could switch between the input and the purge port, with one port always connected to the main fluid gallery 230.

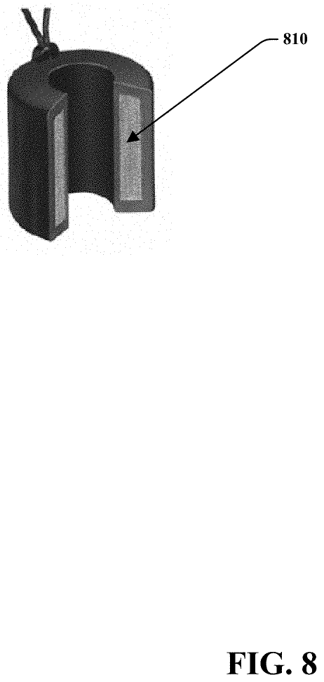

Turning to FIG. 8, freezing of fluid may be controlled by providing at least one heating mechanism. The heating mechanism may be provided to a portion of the fluid distribution manifold 200. For example, a heater, heating element, or heating device or component 810 may be provided in the fluid distribution manifold 200. In an embodiment, the heater may include a Positive Temperature Coefficient (PTC) heater or any other suitable heater. In an embodiment, the heating element may include resistive wire. Heat may be provided by introduction of a current, such as a low current. The current may be provided by a coil. It is noted that heat may be sourced or provided by any suitable means that would prevent the fluid from freezing or expanding to the point of causing damage to the system. The heaters, heating elements, or heating devices or components may be provided within, adjacent, on the exterior, or in thermal contact with any component of the fluid distribution manifold 200 or system, the reservoir 210, pump 220, main fluid gallery 230 and its inputs and outputs thereof, any fluid lines or valves, etc. In an example, the heaters, heating elements, or heating devices or components may be provided underneath the potting of the main fluid gallery 230 or fluid distribution manifold 200, on the exterior of the potting, within the components of the fluid distribution manifold 200, such as the reservoir 210, pump 220, main fluid gallery 230 and its inputs and outputs thereof, any fluid lines or valves, etc., or the heat may be provided in any other suitable location or orientation that prevents freezing of the fluid.

In an embodiment, the PTC heater may be provided underneath the potting of the manifold. The resistive wire may be provided underneath the potting of the manifold. The potting may serve to keep the heater, heating element, or heating device or component fixed in place in the system. In an embodiment, the current and heat may be applied to the valves, see FIG. 8. In an example, the current and/or coils may be low enough not to open the valves, but to keep the valves from freezing. The heaters, heating elements, or heating devices or components may be activated by a switch. In an embodiment, the heat may be activated by a switch that is tripped when in contact with pressures associated with ice formation. This may prevent a drain on the vehicle battery when heat is not needed. Insulation may also be provided to control the temperature of the fluid. Any of the disclosed systems and methods may be strategically incorporated into a portion of the system to selectively control which areas of the system may freeze first. Warmed fluid may also be recirculated in the system to prevent freezing of the fluid.

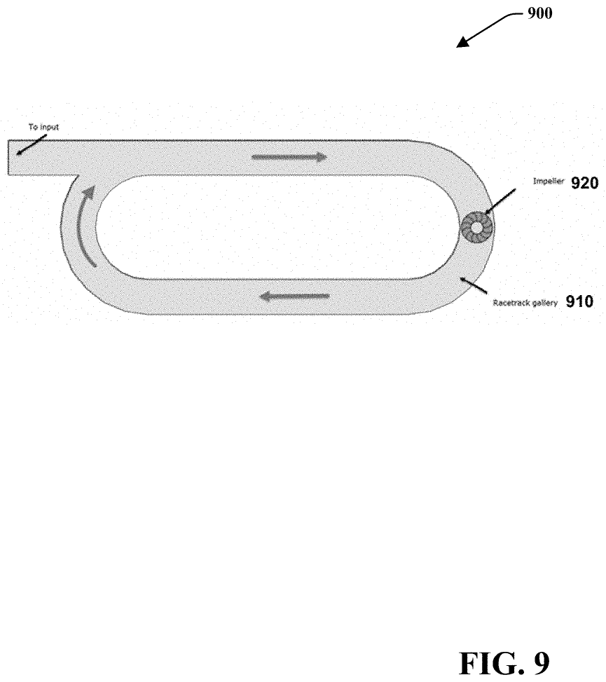

Turning the FIG. 9, the fluid within the system may be also prevented from freezing by recirculation. In this embodiment, provided is a recirculation track 900 in the fluid distribution manifold 200. It is noted that the fluid may also be recirculated in the system by providing a line back into the reservoir 210 or into any portion of the fluid distribution manifold 200 of system, such as the main fluid gallery 230. The recirculation track 900 may include a racetrack gallery or track 910 and an impeller 920 or other device that facilitates the movement of fluid. For example, a pump may be provided in the racetrack gallery in addition to or in place of the impeller 920. Fluid may enter the racetrack gallery 910 and the impeller 920 assist in the continued movement of fluid. In an embodiment, the continued movement of the fluid may prevent the freezing of the fluid. Although FIG. 9 illustrates a gallery in the shape of a racetrack, it is noted that the gallery may be any shape that allows for the flow of fluid and that the entire fluid distribution manifold 200 may be provided as a “racetrack” in an embodiment. The impeller 920 may respond and turn in response to the presence of fluid, or the impeller 920 may be electrically operated. A valve may be provided that selectively allows fluid flow into the racetrack gallery 910, for example, when freezing of the fluid is likely. In an example, the valve may respond to pressure of expanding fluid as described herein, or the valve may open upon input by a temperature sensor, pressure sensor, user, etc.

The components of the fluid distribution manifold 200 may be provided as modular components including the reservoir 210, pump 220, main fluid gallery 230 and its inputs and outputs thereof, any fluid lines or valves, etc. As a result, a fluid distribution manifold may be provided with any number of reservoirs, pumps, fluid galleries, and fluid lines, as well as any number of spring-loaded expansion valves, floating barb expansion valves, three way valves, standpipes, compressed air manifolds, ports to ambient air, cylinders or syringes, drain valves, heating elements, recirculation galleries, etc. The fluid distribution manifold may be customized and adapted to any vehicle.

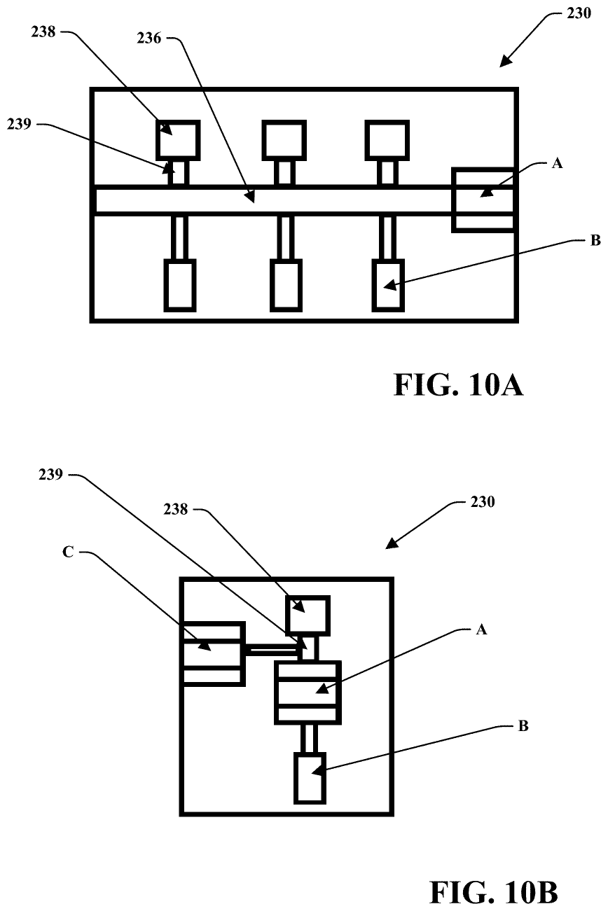

Further, the different disclosed aspects of the fluid distribution manifold, including the reservoirs, pumps, fluid galleries, and fluid lines, as well as any number of the expansion control devices as disclosed and described herein, including spring-loaded expansion valves, floating barb expansion valves, three way valves, standpipes, compressed air manifolds, ports to ambient air, cylinders or syringes, drain valves, heating elements, recirculation galleries, etc., may be oriented in different positions and directions within a manifold 230. As, used herein, expansion control device refers to any of the described freeze/thaw mechanisms as well as mechanisms to prevent freezing or accommodate increase volumes as a fluid freezes, including spring-loaded expansion valves, floating barb expansion valves, three way valves, standpipes, compressed air manifolds, ports to ambient air, cylinders or syringes, drain valves, heating elements, recirculation galleries, etc. As shown in FIGS. 10A-B, a expansion control device may be positioned at the end of the main galley way or main fluid line 236, or edge of the manifold as shown by position A, may be positioned coaxial and adjacent (or opposite to) the valve body 238 or along the main galley way or fluid line 236 as shown by position B, and may be positioned coaxial and adjacent (or opposite to) the fluid line 239 between the valve 238 and main fluid line 236 (the valve inlet/outlet) as shown by position C. FIG. 10A shows a front view of the manifold and FIG. 10B shows a cross-sectional side view of the manifold. It is noted the expansion control device may be placed in any other place along the fluid line of the any part of the manifold as well. In an embodiment, sensors may also be placed in addition to or instead of the expansion control device at each of positions 1-3. Additionally, a pressure sensor may be included in the manifold 232 to aid in regulatory compliance, such as Automotive Integral Safety Level (ASIL) standard compliance as well as for detecting conditions of the system as described herein.

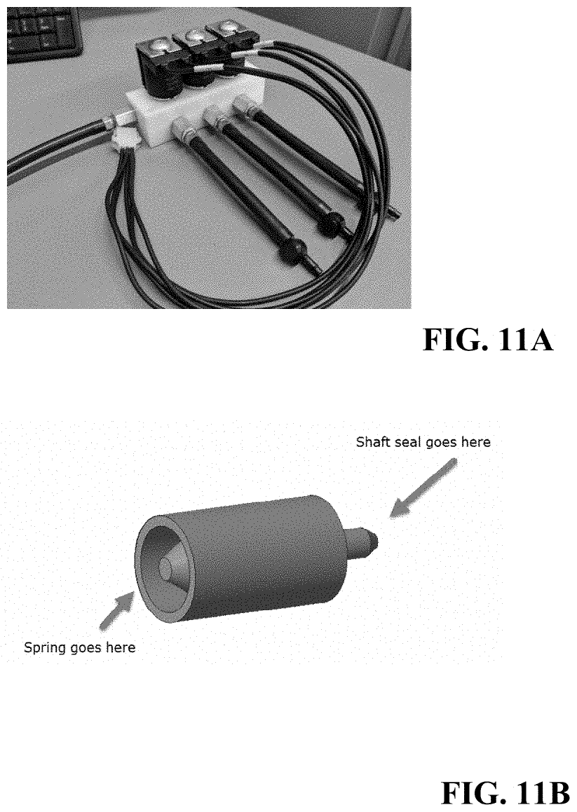

An example of the assembly disclosed herein is provided in FIG. 11A. Here, a manifold was fitted with an expansion valve as disclosed herein. The expansion valve was fitted into the block spring side and the shaft seal sealed off on the gallery, see FIG. 11B. This allowed for a sealed air gap past the carrier. All the block ports were sealed off with check valves and the entire assembly was placed in −40° C. for several hours to complete a freeze of fluid located therein. This was repeated for 15 cycles testing the block and valve function every 5 cycles. As shown in Table 1, the valve block, valve 1, and valve 2 passed the first 10 cycles. The valve block cracked between 10 and 15 cycles, while valve 1 and valve 2 remained functional.

TABLE 1

| | Pass/Fail | | |
|---|---|---|---|
| | 5 Cycles | 10 Cycles | 15 Cycles |
| Valve Block | Pass | Pass | Fail* |
| Valve 1 | Pass | Pass | Pass |
| Valve 2 | Pass | Pass | Pass |

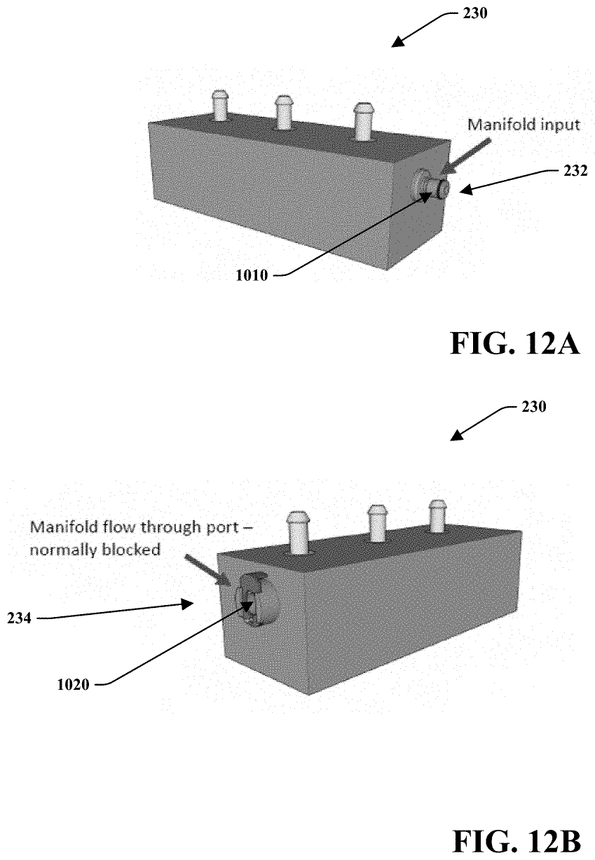

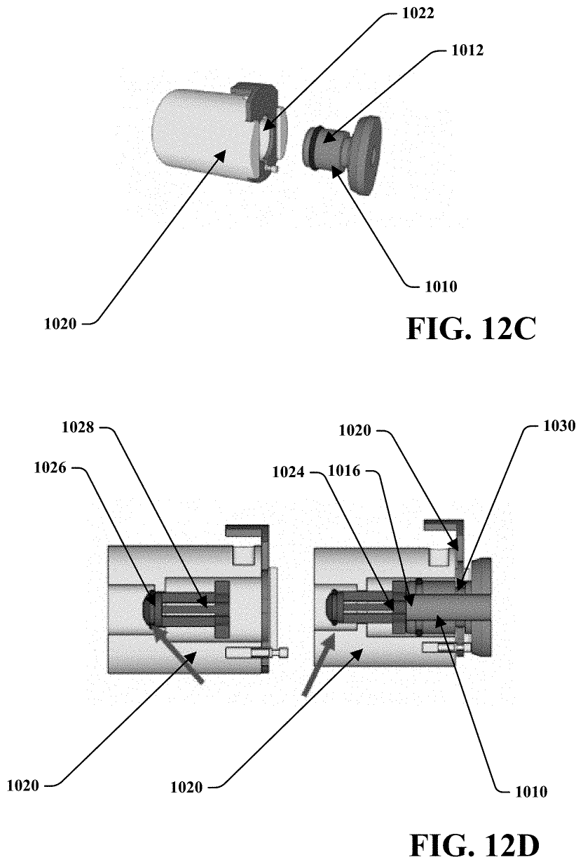

Turning to FIGS. 12-15, various connections between fluid galleries are illustrated. In an example, the connection between any of the components disclosed herein may include quick connect fittings wherein each component includes mating portions. In an embodiment, the mating portions may include a protruding portion and a receiving portion. In an example, the fluid input 232 of the gallery 230 may include a protruding portion 1010 and the fluid output or end 234 of the gallery 230 may include a receiving portion 1020. It is noted that the opposite orientation may also be used. In an embodiment, the protruding portion 1010 of one fluid gallery may interact and connect to the receiving portion 1020 of a second fluid gallery. As shown in FIGS. 12C-D, the protruding portion 1010 be defined by a body 1012 and include a recess 1014 and a contact portion 1016. The receiving portion 1020 may be defined by an opening 1022 and include a contact portion 1024, a sealing portion 1026, a channel 1028, and a catch 1030.

The body 1012 of the protruding portion 1010 may be substantially similar to the opening 1022 of the receiving portion, 1020 such that the two may interlock and mate. The attachments and connections between manifolds 230 may be carried out by one or more fasteners, latches, snaps, protrusions and recesses, projections and apertures, tab and aperture, mating bayonet parts, slot and tab, multiple slots and tabs, any female to male or male to female engagement, adhesives, and the like. The attachments and connections between manifolds 230 may be friction fit, snap fit, pressure fit, or secured by mechanism attachment like a screw or adhesive. As the body 1012 of the protruding portion 1010 enters the opening 1022 of the receiving portion 1020, the contact portion 1016 of the protruding portion 1010 may interact and make contact with the contact portion 1024 of the receiving portion 1020. The contact portion 1024 of the receiving portion 1020 may be pressed and cause the receiving portion 1020 to transition from a closed to an open position opening the sealing portion 1026 and allowing a fluid communication between the two galleries through the channel 1028 of the receiving portion 1020. The catch 1030 of the receiving portion 1020 may engage the recess 1014 of the protruding portion 1010 to secure the two galleries together. When the gallery 230 does not have another component interacting with its receiving portion 1020, the receiving portion 1020 may act as an end or stop to the fluid flow and direct the fluid to another component of the fluid distribution manifold, such as a fluid line or valve. When another component is interacting with the receiving portion 1020 of the gallery 230, the receiving portion 1020 may serve as an outlet and direct fluid flow through the outlet and into the inlet of another device, such as the protruding portion 1010 of a second gallery.

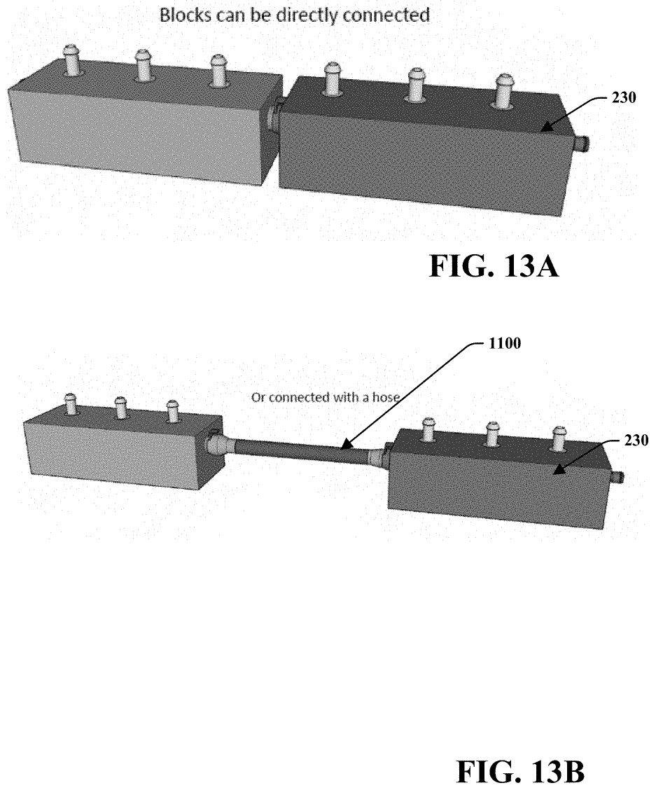

As shown in FIGS. 13A-B, two galleries or manifolds may be connected directly to one another, or a hose 1100 may connect the two galleries. In this embodiment, the hose may itself have a protruding portion and receiving portion that may interact with the corresponding mating portions of the galleries. The fluid lines, valves, reservoirs, and pumps may similarly be connected as disclosed. In an embodiment, the galleries may include any number of lines, 1, 2, 3, 4, 5, etc. lines from the gallery to sensors.

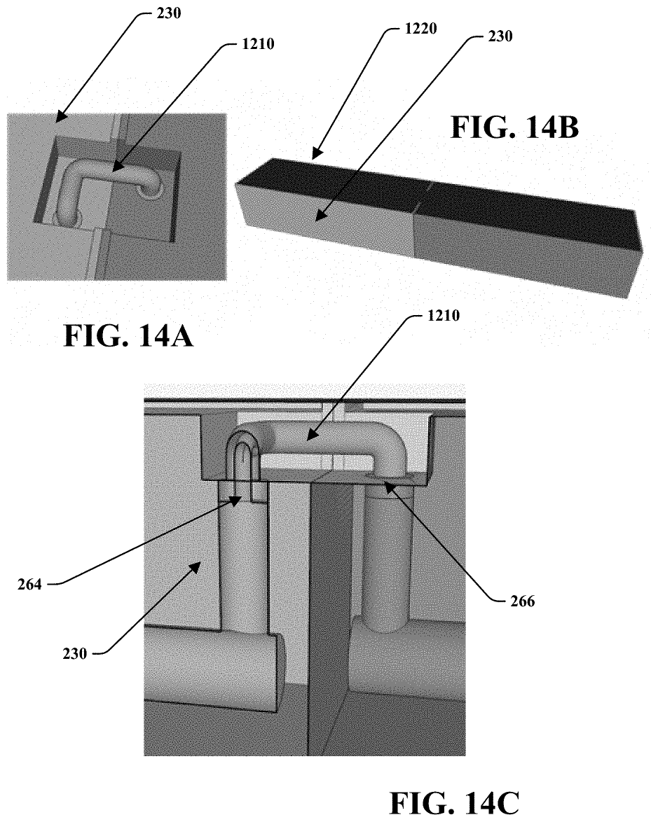

FIGS. 14A-C show an embodiment of connecting components wherein the connection is then sealed within potting. The potting may be a solid or gelatinous compound configured to resist shock and vibrations that also may exclude moisture and corrosive agents. In an embodiment, the galleries can include a snap on connection where a connection pipe 1210 snaps on to each an inlet 264 and an outlet 266 of two galleries. The connection pipe 1210 may then be covered by a potting material 1220 to allow the two galleries to function as a single unit. In an embodiment, a brass ball may be inserted into the seal connecting the channel, or a valve may be used in the channel, to selectively control fluid flow between the two galleries.

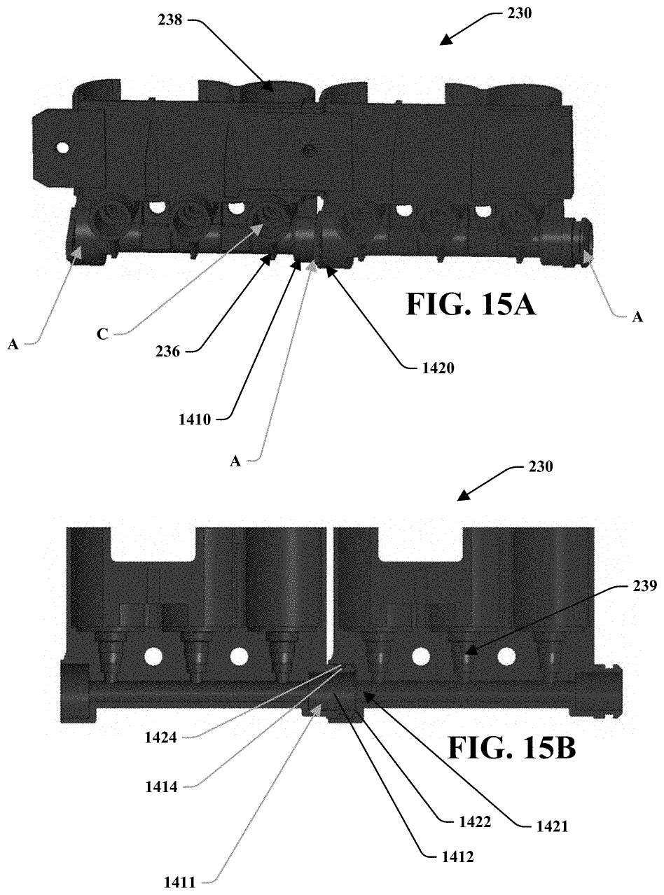

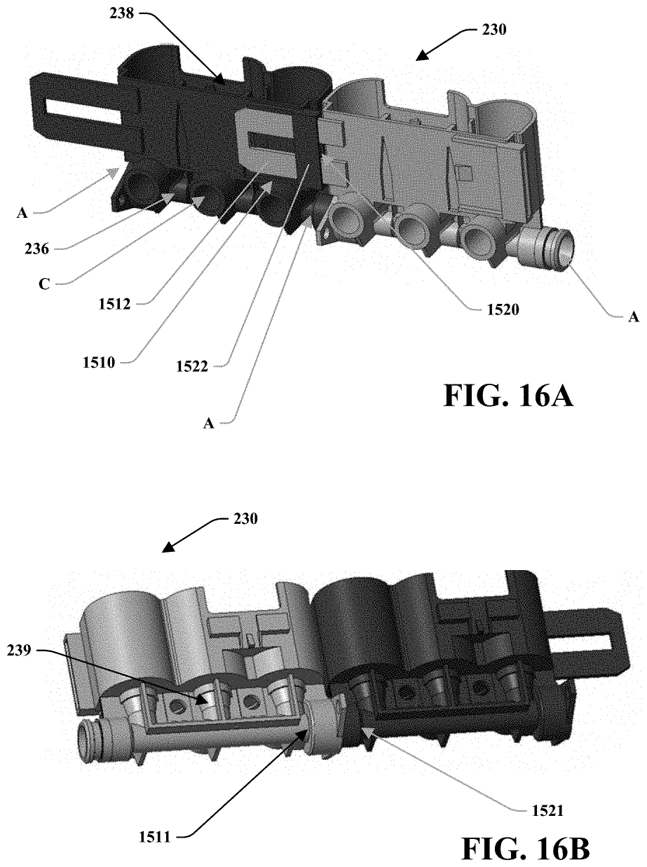

FIGS. 15 and 16 illustrate additional potential embodiments to attach between two galleries or manifolds 230. FIGS. 15 and 16 further illustrate the potential positions of the any of the disclosed expansion control devices, such as position C where an expansion control device can be positioned coaxial and adjacent (or opposite to) the fluid line 239 between the valve 238 and main fluid line 236 (the valve inlet/outlet). In an embodiment, a gallery or manifold may include the same number of expansion control devices as there are sensors, branch valves, galleries, or the like so that each sensor, branch valve, galleries, or the like, and fluid line thereto, may have a corresponding expansion control device. This may ensure that every line is protected from freezing and thawing cycles that would otherwise damage the system. The expansion control devices may be seated in the gallery with the valves and covered in potting material as shown in FIG. 14.

In an embodiment, 1, 2, 3, 4, 5, 6, etc. expansion valves may be positioned throughout the modular liquid distribution manifold assembly independent of the number of sensors, branch valves, or galleries. In an embodiment, expansion control devices may be positioned at either or both the initial inlet or terminal end of the main galley way or main fluid line 236, between connected galleries, and the like, as shown by position A. It is also noted that at this juncture, another fluid line, hose, valve, sensor, end cap, or the like may be attached as well to any of positions A, B, and C as shown in FIGS. 10, 15, and 16. It is also noted that, in addition to being positioned within the galleries, including adjacent or coaxial to branch valves 238, main fluid lines 236, etc., such expansion control devices may be placed in any part of the modular liquid distribution manifold assembly including between the reservoirs, pumps, fluid galleries, and fluid lines.

In FIGS. 15A and B, a fluid connections 1411, 1421, such as fluid input or output, of the gallery 230 may include a first mating portion 1410 and the opposite ended fluid connection 1411, 1421, the fluid output or input respectively, of the gallery 230 may include a corresponding second mating portion 1420. It is noted that a first manifold may have a first end with an inlet and first mating portion and a second end with an outlet and mating portion, and that a second manifold may have the same structure as the first manifold. In an embodiment, the first mating portion 1410 may include a protruding body 1412 and the second mating portion 1420 may include an opening 1422. It is noted that the opposite orientation, e.g. the first mating portion 1410 including an opening and the second mating portion 1420 including a protrusion is also a possible configuration. In an embodiment, the first mating portion 1410 of one fluid gallery may interact and connect to the second mating portion 1420 of a second fluid gallery. As shown in FIGS. 15A-B, the protruding body 1412 may include a recess or aperture 1414 and the opening 1422 may include a contact portion or catch 1424.

The protruding body 1412 of the first mating portion 1410 may include surfaces having a generally complementary shape relative to the opening 1422 of the second mating portion 1420 such that the two may interlock and mate. The attachments and connections between manifolds 230 may be carried out by one or more fasteners, latches, snaps, protrusions and recesses, projections and apertures, tab and aperture, mating bayonet parts, slot and tab, multiple slots and tabs, any female to male or male to female engagement, adhesives, and the like. The attachments and connections between manifolds 230 may be friction fit, snap fit, pressure fit, or secured by mechanism attachment like a screw or adhesive. As the protruding body 1412 of the first mating portion 1410 enters the opening 1422 of the second mating portion 1420, the catch 1424 in the opening 1422 may engage the recess 1414 of the protruding body 1412. The contact between manifolds 230 may transition the connected inlets and outlets 232, 234 from a closed to an open position allowing a fluid communication between the two manifolds through the channel 1428. The engagements between the catch 1424 and recess 1414 may secure the two galleries together. When the gallery 230 does not have another component interacting with its inlet or outlet 1411, 1421, the inlet and outlet 1411, 1421 may be in a closed position and may act as an end or stop to the fluid flow and direct the fluid to another component of the fluid distribution manifold, such as a fluid line or valve.

FIGS. 16A-B further show another method of connectivity between manifolds 230 that may be used in conjunction with the inlet/outlet connectivity as shown and described in FIGS. 12A-B and 15A-B, or that may be used alone or with another method of connectivity, such as welding, adhesive, and the like. In order to secure and stabilize the full vertical body of the manifolds 230, the manifolds may include another set of mating portions that insert into one another. For example, a first manifold 230 may include a first mating portion 1510 that is a protrusion 1512 on a first end, such as the inlet 1511 or outlet end 1521. The manifold 230 may include a second mating portion 1520 that includes a receiving portion 1522 on the opposite end, such as the outlet 1521 or inlet and 1511, wherein the receiving portion 1522 is configured to receive the protrusion 1512 of another manifold. The attachments and connections between manifolds 230 may be carried out by one or more fasteners, latches, snaps, protrusions and recesses, projections and apertures, tab and aperture, mating bayonet parts, slot and tab, multiple slots and tabs, any female to male or male to female engagement, adhesives, and the like. The attachments and connections between manifolds 230 may be friction fit, snap fit, pressure fit, or secured by mechanism attachment like a screw or adhesive. In an embodiment, the first mating portions 1510 and second mating portions 1520 of the mating may extend a portion or substantially all of the vertical height of the manifolds. As a result, the manifolds may be secured together, along their vertical height (e.g. top and bottom or near top and near bottom) by a single engagement between a first mating portion 1510 and a second mating portion 1520. In an embodiment, the manifolds may have multiple smaller engagement features that are spaced apart along the vertical height of the manifolds to achieve a similar securement between manifolds, but with more than one engagement. For example, the manifolds may include 2, 3, 4, 5, 6, or more engagement features to connect between manifolds.

It is noted that any of the systems and methods disclosed herein may utilize mechanical switches such as a switch that is activated by the pressure of freezing or expanding fluid, electrical switches, or any other switch that selectively activates the disclosed systems and methods. The switches may be activated by pressure, temperature, or other environmental readings, by a scheduled or automated system, or by a user's input.

It is noted that any of the systems and methods disclosed herein may utilize a temperature sensor that transition of any of the expansion or three-way valves between an open and closed position, evacuation of the manifold, heating of the manifold, etc. may occur when the temperature drops below a certain threshold. Temperature sensors may also be used to indicate the temperature of the fluid and to verify whether certain disclosed systems and methods, such as heating of the manifold, may be working. It is further noted that any of the systems and methods disclosed herein may utilize a pressure sensor to control actuation of the systems and methods based on a change in pressure that may signify freezing of the fluid. The systems and methods disclosed herein may also be actuated by the change in pressure itself, for example, the increased pressure of freezing fluid may itself activate a particular disclosed system. Additionally, the actuation of these systems and methods may be set to activate when the vehicle turns off, or when the vehicle turns on. Any of these disclosed options may be paired with a liquid sensor that verifies expansion of fluid into and expansion valve, that the manifold has been evacuated to a sufficient level, or any other information related to the presence or absence of fluid within the system.

It is noted that any of the systems and methods disclosed herein may be provided in all or a portion of the system, and may be combined with each other. It is noted that any of the disclosed systems and methods may be strategically incorporated into a portion of the system to selectively control which areas of the system may freeze first.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A modular liquid distribution manifold assembly for use in a sensor cleaning system configured to clean at least one sensor mounted to a vehicle, the modular liquid distribution manifold assembly comprising:
a first fluid gallery or housing including a main fluid line, at least one branch valve, an inlet, and an outlet member, said main fluid line is attached to and in fluid communication with the inlet, the branch valve, and the outlet member, the inlet is configured to be placed in fluid communication with a fluid reservoir and said branch valve is configured to be attached to a fluid line;
the outlet member is positioned along an exterior portion of said fluid gallery and is configured to be attached to a second fluid gallery, wherein the outlet member is placed in a normally closed position; and
at least one expansion control device positioned in communication with at least one of the inlet, the main fluid line, the branch valve, and the outlet member, said expansion valve configured to reduce fluid pressure within the liquid distribution manifold due to freezing and thawing of the fluid.

2. The modular liquid distribution manifold assembly of claim 1, wherein said fluid gallery includes a plurality of branch valves wherein each of said branch valves are configured to be placed in an open and closed position to distribute fluid to fluid lines and nozzles attached thereto to spray fluid therefrom to clean a sensor positioned along an exterior of a vehicle

3. The modular liquid distribution manifold assembly of claim 1, wherein the expansion control device is a spring-loaded expansion valve that includes an expansion pocket.

4. The modular liquid distribution manifold assembly of claim 3, wherein the expansion pocket is spring-loaded and biased to a closed position.

5. The modular liquid distribution manifold assembly of claim 3, wherein the expansion control device is a three way spring-loaded valve wherein an inlet of the expansion control device is also serves as an outlet.

6. The modular liquid distribution manifold assembly of claim 3, wherein the expansion pocket is configured to receive overflow fluid when the fluid drops below a freezing temperature.

7. The modular liquid distribution manifold assembly of claim 3, wherein the expansion pocket is in a closed position when the fluid is above a freezing temperature and operatively opens into an open position when the fluid is below the freezing temperature.

8. The modular liquid distribution manifold assembly of claim 1, wherein the expansion control device includes a release valve.

9. The modular liquid distribution manifold assembly of claim 8, wherein the release valve is spring-loaded and biased to a closed position.

10. The modular liquid distribution manifold assembly of claim 8, wherein an outlet of the release valve is open to ambient air.

11. The modular liquid distribution manifold assembly of claim 1, wherein the expansion control device is configured to receive ambient or compressed air to purge fluid from the liquid distribution manifold.

12. The modular liquid distribution manifold assembly of claim 1, wherein the expansion control device includes a heating mechanism.

13. The modular liquid distribution manifold assembly of claim 1, wherein the expansion control device includes a recirculation system.

14. The modular liquid distribution manifold assembly of claim 1, wherein the expansion control device is positioned at an end of the first fluid gallery.

15. The modular liquid distribution manifold assembly of claim 1, wherein the outlet member is placed in an open condition and is attached to a second fluid gallery, the second fluid gallery having a main fluid line, at least one branch valve, an inlet, and an outlet member, said main fluid line is attached to and in fluid communication with the inlet, the at least one branch valve, and the outlet member, the inlet is placed in fluid communication with the first gallery and said branch valve is configured to be attached to a fluid line.

16. The modular liquid distribution manifold assembly of claim 15, wherein the first fluid gallery and the second fluid gallery are connected by male and female mating portions.

17. The modular liquid distribution manifold assembly of claim 15, wherein the first fluid gallery include an elongated protrusion and the second gallery includes a receiving portion wherein the receiving portion is configured to receive the elongated protrusion such that the elongated protrusion and the receiving portion are spaced from the outlet member and the inlet of the second fluid gallery.

18. A method of cleaning a plurality of sensors mounted to an exterior of a vehicle comprising:
providing a modular liquid distribution manifold including a first fluid gallery having a main fluid line, a plurality of branch valves, an inlet, and an outlet member, said main fluid line is attached to and in fluid communication with the inlet, the plurality of branch valves, and the outlet member, the inlet is fluid communication with a fluid reservoir and a pump, said plurality of branch valves are attached to a plurality of fluid lines having a plurality of nozzles such that said nozzles are placed along an exterior of a vehicle and each of the plurality of nozzles are placed adjacent to a sensor;
sensing, with at least one sensor, the presence of debris;
controlling, with the processor, at least one of the plurality of branch valves to place said branch valve in an open position;
controlling, with the processor, the pump to cause fluid flow through the liquid distribution manifold; and
spraying fluid from at least one of said plurality of nozzles to clean debris from the at least one sensor.

19. The method of claim 18 further comprising providing at least one expansion control device positioned in communication with at least one of the inlet, the plurality of branch ports, and the outlet, said expansion valve configured to reduce fluid pressure within the liquid distribution manifold due to freezing and thawing of the fluid.

20. The method of claim 18 further comprising providing a second fluid gallery and attaching said second fluid gallery to the first fluid gallery, the second fluid gallery having a main fluid line, at least one branch valve, an inlet, and an outlet member, said main fluid line is attached to and in fluid communication with the inlet, the branch valve, and the outlet member, the inlet is fluid communication with the first fluid gallery to increase the number of nozzles controlled by the liquid distribution manifold.
